(19) United States
(12) Patent Application Publication
(10) Pub. No.: US 2015/0204649 A1
(43) Pub. Date: Jul. 23, 2015

(54) INDOOR LOCATION USING MAGNETIC FIELDS

(71) Applicant: Cambridge Silicon Radio Limited, Cambridge (GB)

(72) Inventors: Anthony McFarthing, Ely (GB); James Burgess Tidd, Stockholm (SE)

(73) Assignee: Cambridge Silicon Radio Limited, Cambridge (GB)

(21) Appl. No.: 14/160,812

(22) Filed: Jan. 22, 2014

(51) Int. Cl. G01B 7/14; G01S 19/06; G01S 19/13; G01S 5/02

(52) U.S. Cl. CPC G01B 7/14; G01S 5/0252; G01S 5/0263; G01S 19/06; G01S 19/13

(57) ABSTRACT

A location system that employs multiple magnetic transmitters that provide magnetic fields modulated with respectively different identifying signals. A magnetic receiver extracts the identifying signal from the modulated magnetic field to determine its location. The magnetic transmitters may be configured as magnetic signal sources including magnetic pseudolites. The identifying signals are repeated at predetermined intervals such that the magnetic receiver accumulates the repeated identifying signals to provide processing gain.

### BACKGROUND

The subject invention concerns indoor location techniques using magnetic fields and, in particular, accumulating repetitively transmitted data using a magnetic field receiver.

Presently, the main techniques used for geolocation are satellite positioning systems (SPS), such as the Global Positioning System (GPS), cell tower colocation and trilateration using cell tower signals. SPS systems provide accurate locations using signals received from orbiting satellites. Problems arise for receivers located within buildings where the permittivity of materials in the building cause the amplitudes of received radio frequency (RF) signals, both SPS satellite signals and cellular telephone signals to be severely attenuated.

There are currently three main techniques in indoor positioning. The first relies on using inertial sensors to detect motion of the device to be located, the second relies on detecting the signals from RF transmitters (such as WiFi, GSM, IMES, Bluetooth) to locate a receiving device using fingerprinting, trilateration or triangulation, and the third relies on fingerprint data generated from ambient effects such as the Earth's magnetic field and/or barometric pressure.

The first technique is a relative system, and relies on absolute positions for initializing and minimizing the growth of positioning errors. The second technique relies on there being a transmitter infrastructure in place, either dedicated to positioning or that can be used for positioning. This may require installation of transmitters to ensure a minimum level of performance. The third technique relies on the ambient environment being constant, at least in relative terms.

Furthermore, even with these indoor positioning signals, variations in the permittivity of materials within buildings may result in reflections and attenuation of the signals that may degrade the performance of any RF system.

### SUMMARY

The present invention is embodied in a location system that employs multiple magnetic transmitters that provide magnetic fields modulated with respectively different identifying signals. A magnetic receiver extracts the identifying signal from the modulated magnetic field to determine its location.

In one example implementation, the identifying signals are repeated at predetermined intervals and the magnetic receiver accumulates the identifying signals received during multiple intervals.

In another example implementation, multiple magnetic transmitters are positioned in a space. The magnetic receiver determines its location by collocating the receiver with one of the magnetic transmitters having a strongest signal.

In yet another example implementation, the magnetic receiver determines its position based on fingerprint data derived from the multiple magnetic transmitters.

According to another example implementation, the magnetic receiver is configured to determine its angular position with respect to a plurality of the magnetic transmitters and to determine its location by triangulation.

According to yet another example implementation, the identifying signals are respective satellite positioning signals and the magnetic receiver is configured to process the satellite positioning signals according to a satellite positioning algorithm to determine its location.

In one example implementation, the magnetic transmitters are near-field communication (NFC) transmitters.

The proposed system of transmitters may also have a receive capability so the devices in the system that receive positioning information have capability to transmit messages back again. The magnetic transmitters are then potentially magnetic transceivers

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. According to common practice, the various features of the drawings are not drawn to the scale. Also, the dimensions of the various features are arbitrarily expanded or reduced for clarity. Included in the drawings are the following figures:

FIGS. 1A and 1B are block diagrams of example magnetic transmitters.

FIG. 1C is a schematic diagram of an example magnetic antenna.

FIG. 1D is a block diagram of an example receiver, including both magnetic and RF receiver circuits.

FIGS. 1E and 1F are block diagrams of example demodulating signal processing circuits suitable for use with the receiver shown in FIG. 1D.

FIGS. 2, 3 and 4 are top-plan views of a floor of a building that are useful for describing respective example magnetic location methods.

FIG. 5 is an isometric view of a building that is useful for describing another example magnetic location method.

FIG. 6A is a graph of antenna coupling versus distance for a magnetic transmitter and receiver.

FIG. 6B is a graph of measured receiver voltage versus antenna separation for a magnetic receiver.

### DETAILED DESCRIPTION

As described above, indoor RF location systems may be difficult to operate due to the signal reflections and absorption resulting from the permittivity of materials in the building. For magnetic signals, permeability, not permittivity, is the most relevant material property. Changes in the relative values of permeability may affect magnetic field levels. Many of the materials used in modern buildings, however, including aluminum, concrete, wood, plastic, stone, stainless steel and glass have permeabilities that are approximately the same as the permeability of free space (or air). thus magnetic fields penetrate buildings without interference. Ferromagnetic materials, such as iron, nickel and cobalt have a high permeability and can attenuate, distort or block magnetic signals.

The embodiments described below employ magnetic beacon transmitters and magnetic receivers for location determination. Some example magnetic transmitters send repeating identification signals as their beacons. The magnetic receivers capture and accumulate the beacon signals to provide a processing gain. In one implementation, a standard NFC transmitter having a signal frequency of 13.56 MHz and a drive current of only about 400 ρA is used as the magnetic transmitter. Using the processing gain resulting from accumulating a repeating signal these low power signals can be effectively detected at a range of between 100 m and 200 m.

The magnetic field location systems, described below, may be affected by the presence of ferromagnetic materials, such as steel desks or steel wall studs in the environment being monitored. These ferromagnetic materials may distort the magnetic fields sensed by the magnetic receivers, for example, by creating local dead zones where the magnetic field is very weak.

In addition, the magnetic location systems may be affected by eddy current noise. Eddy current noise is caused by electrically conductive material in the monitored environment. Time-varying magnetic fields generate eddy currents in the electrically conductive materials which, in turn, generate magnetic fields. The amplitude of the voltage, Vi, of the eddy current induced by a time-varying magnetic field having a frequency ω is proportional to the area of the object and the frequency of the time-varying field, as shown by equation (1).

Vi∝ωA sin(ωt) (1)

where A is the area of the conductive surface.

Thus, the voltage, and thus, the magnetic field induced by the eddy current is proportional to the area of the conductive surface and to the frequency of the time-varying magnetic field (referred to herein as the magnetic signal). The direction of the magnetic field induced by the eddy current is perpendicular to the conductive surface and has an opposite phase to the signal that magnetic signal that induced it. Although eddy current noise is a second-order effect and is typically much weaker than the magnetic field which induced it, eddy current noise may affect signal strength measurements, causing sensed magnetic fields to appear weaker than they would be without the eddy current noise. With the increased use of engineering plastics in place of metal, magnetic field distortion resulting from ferromagnetic materials or relatively large conductive surfaces is becoming less of a problem.

The systems described below may be used for location within a building or even below ground. The magnetic beacon transmitters are, desirably, mounted in the building taking into account the locations of any rolled steel joists (RSJs) (e.g. steel girders) or other ferromagnetic materials as well as conductive surfaces having relatively large surface areas. The beacon transmitters may, for example, be placed at a predetermined distance, for example, 2 m away from any such ferromagnetic objects and placed such they are not obstructed by any relatively large conductive surfaces. The placement of magnetic beacon transmitters does not need to be accurate, as the properties of the location determination algorithms described below compensate for inaccurate placement allowing location accuracy to be maintained. Furthermore, magnetic receivers are desirably placed away from ferromagnetic objects and relatively large conductive objects when receiving magnetic signals.

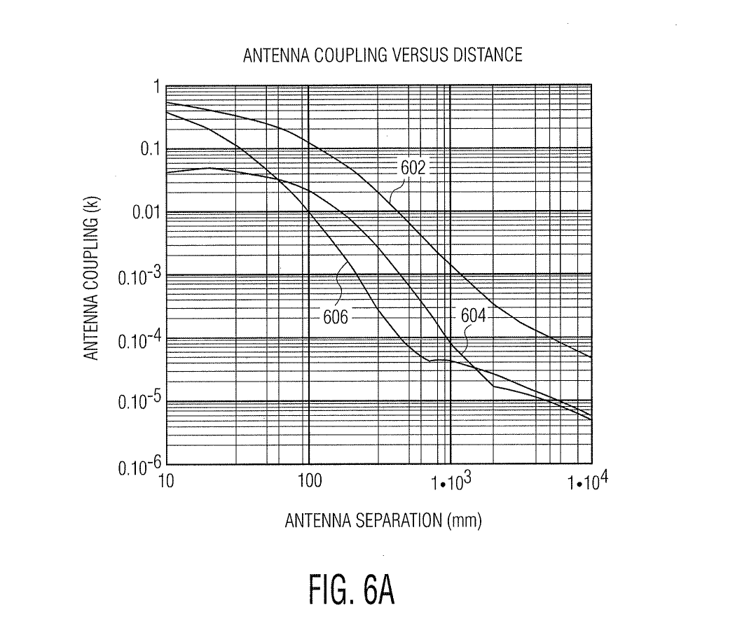

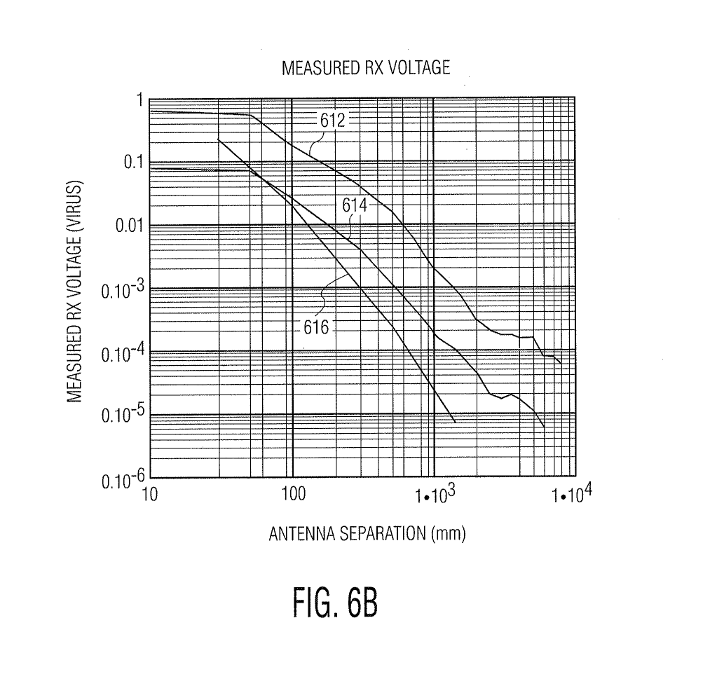

Determination of the effective operational distances of this system is a function of the transmitter power, the sizes of the respective transmitting and receiving antennas, the presence of ferromagnetic objects or objects that may cause eddy current noise, and the amount of signal accumulation. FIGS. 6A and 6B show examples using antennas commonly found in NFC or radio frequency identification (RFID) devices in an unobstructed environment. For distances up to 10 m three different pairs of antennas can produce good coupling properties for antennas of the size of an A4 sheet of paper (297 mm×210 mm) or of the size of a credit card (PICC1) (72 mm×42 mm). FIG. 6A shows the coupling for the three different pairings of these antennas. The curve 602 shows the coupling between two A4-sized antennas, curve 604 shows the coupling between an A4 antenna and a PICC1 antenna and curve 606 shows the coupling between two PICC1 antennas. FIG. 6B shows the voltage received at the receiver's antenna as a function of antenna separation. Curves 612, 614 and 616 correspond respectively to two A4 antennas, an A4 and a PICC1 antenna and two PICC1 antennas. From FIG. 6B, it is noted that a useful signal level of about 10 uV can be generated with modest drive settings with magnetic antenna couplings as low as 10⁻⁶ at 10 m (extrapolated).

If these curves are extrapolated further to 100 m the signal may be reduced by another 20 dB. Processing gains that can be achieved by accumulating a repeated signal, however, are between 50 to 100 dB. Levels of noise in a magnetic receiver are much lower than in conventional electromagnetic (EM) receivers so it is contemplated that the processing gain resulting from such accumulation, for example, the processing gain of a GPS receiver, may be used to recover the magnetically modulated signals to useable levels even when standard NFC transmitters and receivers are used.

Thus, using magnetic beacon transmitters and magnetic receivers instead of or in addition to RF transmitters and receivers may provide alternative location techniques that provide better performance, lower cost and/or lower power consumption than purely RF systems.

The implementations described below use magnetic beacons and/or signal sources and optionally RF beacons and/or signal sources to determine the location of a receiver in an indoor environment.

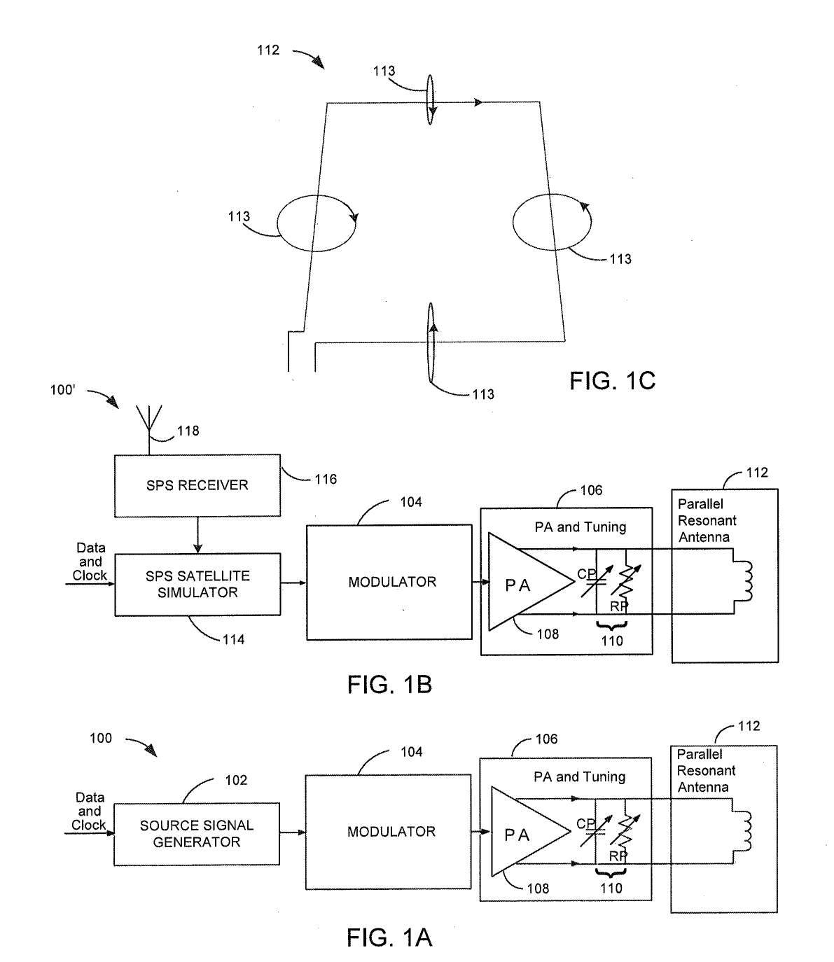

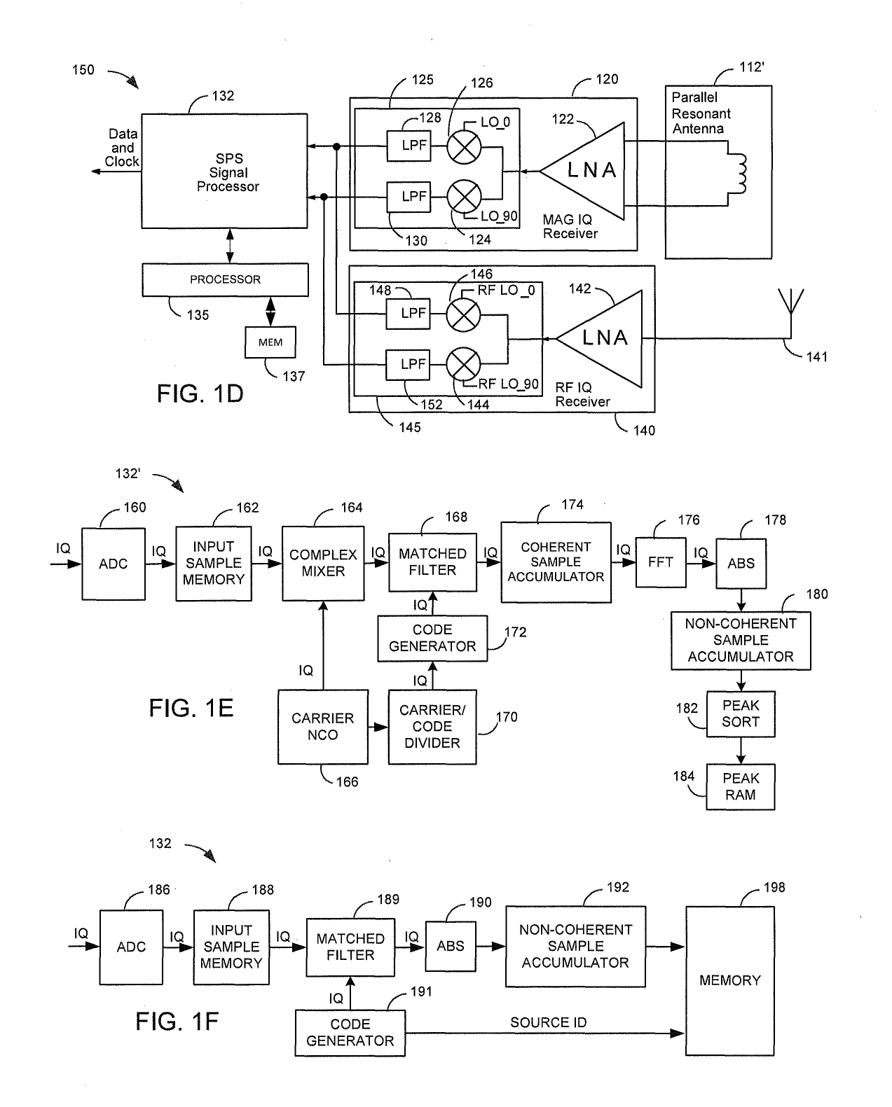

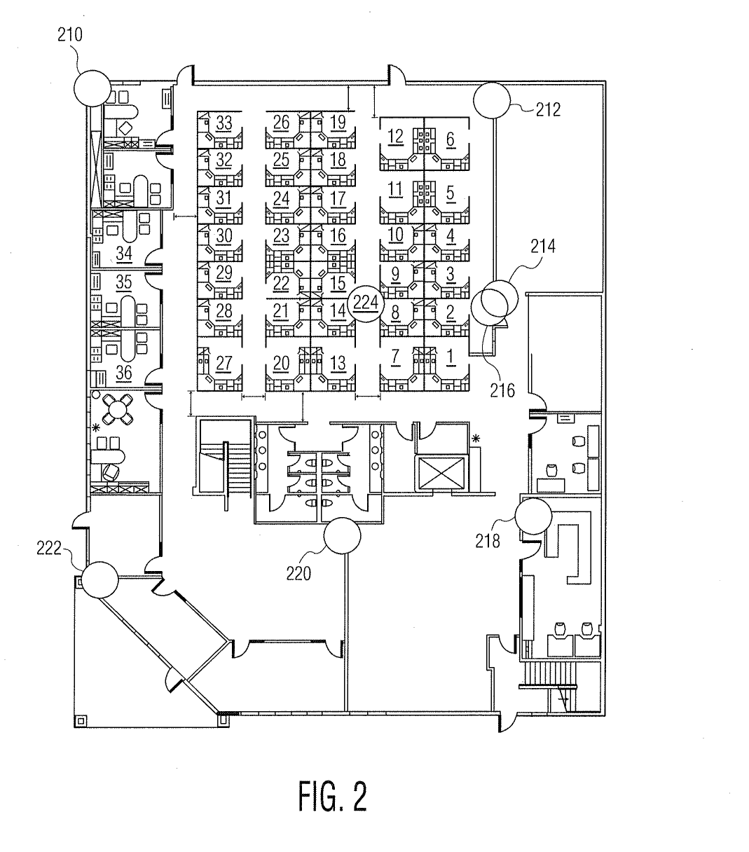

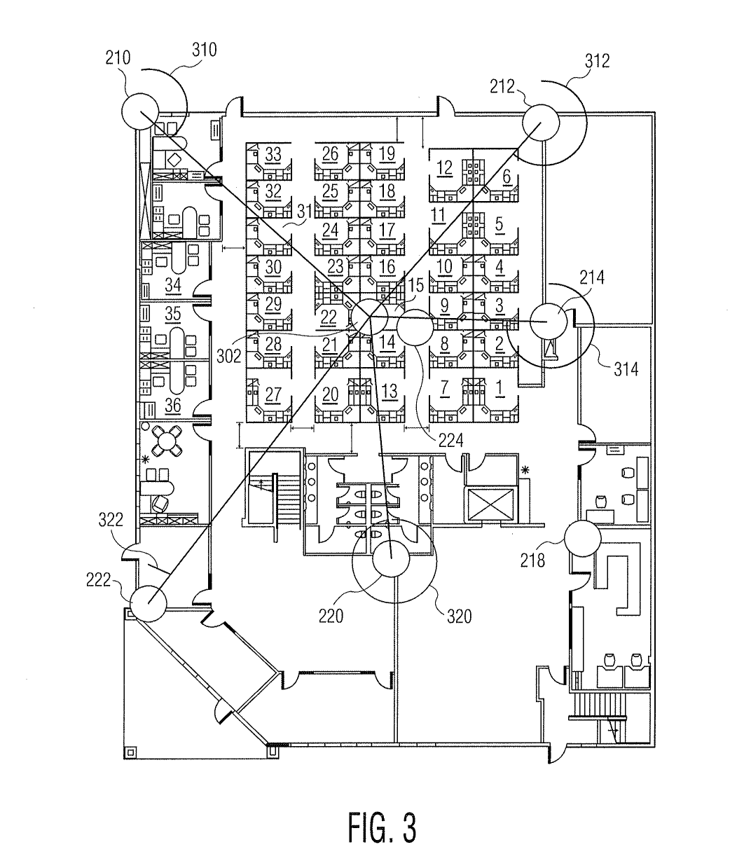

FIG. 1A is a block diagram, partly in schematic diagram form, of an example magnetic transmitter 100. The transmitter 100 includes a source signal generator 102, a modulator 104, a circuit 106, including a power amplifier 108 and an antenna tuning circuit 110, and a parallel resonant antenna 112. The source signal generator 102 may, for example, generate a known identification sequence that repeats in a predetermined interval. An example of such a code is the Basic Service Set Identification (BSSID) used in WiFi. Alternatively, the sequence may be a pseudo-random sequence, such as a Gold code or Walsh code, that has little or no correlation with codes used by other transmitters and that repeats at predetermined intervals. The signal produced by the signal generator 102 is applied to the modulator 104 which modulates a carrier current signal. The modulated current signal, in turn, is applied to the power amplifier 108 which amplifies the modulated signal. While the identification sequence is described as a 1024 bit Gold code or Walsh code, it is contemplated that other sequences may be used. In particular, the sequence may have more or fewer bits, may not be a Gold code or Walsh code and may not be pseudo-random. Any repeating identification code may be used.

The described systems include multiple magnetic transmitters. To maximize the ability of the receiver to distinguish among the codes transmitted by the various transmitters, it is desirable to minimize cross-correlation among the codes. The Gold codes describe a set of code sequences that have relatively small cross-correlation. Alternatively, the system may employ mutually orthogonal codes, for example Walsh codes. As yet another alternative, the system may use pseudo-random number (PN) codes that are selected as having small cross-correlation among any code in the set and all other codes. Codes that are not PN codes may be manually generated to have a desired level of cross-correlation.

The tuning circuit 110 includes a capacitor CP and a resistor RP that are used to tune the parallel resonant antenna 112 to maximize its coupling to the corresponding antennas of the receivers. The tuning circuit may be used, for example, to tune the antenna 112 such that the combination of the antenna 112 and tuning circuit 110 resonate at the carrier frequency of the magnetic signal. The tuning circuit may, for example, compensate the antenna 112 for any nearby objects having significant permeabilities. An example tuning system is described in U.S. published application no. 2013/0281016 to McFarthing entitled “Transceiver,” the contents of which are incorporated herein by reference for their teaching on magnetic modulation and antenna tuning.

FIG. 1B is a block diagram, partly in schematic diagram form, of an alternative example magnetic transmitter 100′. This transmitter emulates a GPS pseudolite. An example radio-frequency pseudolite is described in U.S. Pat. No. 7,142,159 to Farley entitled “Pseudolite Navigation System” which is incorporated herein by reference. Although the system is described as implementing a GPS pseudolite, it is contemplated that pseudolites of other SPS systems may be emulated, including GLONASS, Galileo, IRNSS and BeiDou.

The magnetic transmitter 100′ shown in FIG. 1B includes the modulator 104, power amplifier 108 and tuning circuit 110 and parallel resonant antenna 112 described above with reference to FIG. 1A. In addition, the transmitter 100′ includes a GPS satellite simulator 114 and an RF GPS receiver 116 that receives GPS satellite signals via an RF antenna 118. The GPS satellite simulator 114 may be, for example, the Personal Computer Signal Generator and GNSS Signal Simulator (PCSG and GSS) device sold by Rockwell Collins.

The transmitter 100′ is desirably located near the roof or an outside wall of the building so that the antenna 118 and, optionally, the GPS receiver 116 may be positioned to receive GPS satellite signals. Using these signals, the GPS receiver 116 may determine its position and obtain an accurate time reference from the GPS satellites. As described below, this time reference may be shared with other magnetic pseudolites that may have a communications link, either wired or wireless (not shown) with the satellite simulator 114 to synchronize the pseudolites.

The magnetic transmitter shown in FIGS. 1A and 1B may also include magnetic receivers such as the magnetic receiver 120 described below with reference to FIG. 1D as well as the signal processing circuitry shown in FIG. 1E or 1F. The magnetic transceivers may also include the signal processing circuitry shown in FIGS. 1E and 1F. The use of magnetic transceivers may be desirable for use in magnetic location systems that employ the range timing or return time transit methods, described below.

FIG. 1C is a perspective drawing of an example parallel resonant antenna 112. Although the antenna 112 is shown as being rectangular and having a single loop of wire, it is contemplated that it may be circular or rectangular with rounded corners and have several loops of wire. The reactive impedance of the antenna 112 is desirably selected such that the antenna 112 may be tuned, using the tuning circuitry 110, shown in FIGS. 1A and 1B, to resonate at the magnetic carrier frequency of the modulator 104. The circles 113, shown in FIG. 1C illustrate the magnetic fields emitted by the antenna.

FIG. 1D is a block diagram, partly in schematic diagram form, of an example receiver 150. The receiver includes a magnetic receiver 120 and an optional RF receiver 140. The magnetic receiver 120 includes a parallel resonant antenna 112′ which may be the same as the antenna 112, described above. The antenna 112′ is coupled to a low noise amplifier (LNA) 122 which, in turn, is coupled to a synchronous demodulator 125. The demodulator 125 includes two local oscillators, LO_0, which generates an in-phase (I) local oscillator signal, and L0_90, which generates a quadrature-phase (Q) local oscillator signal. These signals are applied to respective multipliers 126 and 124 to demodulate the received and amplified magnetic signal into respective I and Q components. The I and Q component signals are filtered by respective low-pass filters 128 and 130 to provide baseband I and Q signals to the demodulating signal processor 132.

Alternatively, instead of a synchronous demodulator, the circuit 125 may be a complex mixer that combines the received magnetic signal with local oscillator signals to generate intermediate frequency (IF) I and Q signals that are applied to the demodulating signal processor 132. In this instance, the processor 132 may further demodulate the I and Q signals to produce the baseband signals. As described below, the baseband signals are processed by the signal processor 132 and a processor 135 to determine the location of the receiver 150.

The processor 135 may be coupled to a memory 137, including a random-access memory and, optionally, a secondary memory. An example secondary memory may include a hard disk (e.g., a magnetic disk, an optical disk, a magneto-optic disk, a solid state disk, etc.) or some other type of computer-readable medium, along with a corresponding drive. A computer-readable medium may be defined as a non-transitory memory device. The memory 137 may include space within a single physical memory device or be spread across multiple physical memory devices.

The receiver 150 may also include an RF receiver 140. The RF receiver may, for example, have an RF antenna 141 that receives RF GPS satellite signals the receiver 140 demodulates these signals to provide I and Q baseband or I and Q IF signals to the demodulating signal processor 132. The RF receiver includes an LNA 142, multipliers 146 and 144 configured to receive the RF signal from the low-noise amplifier and respective RF local in-phase and quadrature oscillator signals, RF_LO_0 and RF_LO_90. The baseband or IF I and Q signals provided by the multipliers 146 and 144 are applied to respective low-pass filters 148 and 152 to produce the output signals applied to the demodulating signal processor 132.

In one example embodiment, the magnetic receiver 120 receives magnetic GPS signals provided by the GPS transmitter shown in FIG. 1B. In this embodiment, the signals modulate a 13.56 MHz magnetic carrier. The magnetic receiver 120 in this example generates IF GPS signals that are applied to the processor 132. Similarly, the example RF receiver 140 receives RF GPS signals in a frequency band between 1.215 and 1.260 GHz. These signals may be downconverted using, for example, a prescaler (not shown), before being applied to the RF receiver 140. The output signals of the example RF receiver 140 are IF GPS I and Q signals having the same IF frequency as the signals provided by the magnetic receiver 120. As set forth above, the magnitude of the eddy current noise is proportional to the frequency of the magnetic carrier. Thus, at least in environments with electrically conductive objects, it may be desirable to use a lower carrier frequency than 13.56. MHz. Lowering the frequency of the carrier signal, however, is balanced against the repetition of the identifying signal. A lower carrier signal may result in a longer time to achieve a desired number of repetitions. It is contemplated that carrier frequencies in a range from 100 KHz to 50 MHz may be used.

The receiver 150, shown in FIG. 1D is configured to receive both RF and magnetic GPS signals. The magnetic RF signals are pseudolite signals, generated by a transmitter, such as the transmitter described above with reference to FIG. 1B. The RF GPS signals may be satellite signals or signals generated by one or more RF pseudolites, such as described in the above referenced patent. Because the same demodulating and signal processing circuitry is used to receive both the magnetic pseudolite signals and the RF satellite or pseudolite signals and because the magnetic receiver operates at the same frequency as existing NFC receivers, the receiver shown in FIG. 1D may be implemented with relatively minor modifications of an existing smart phone that includes a GPS receiver and an NFC receiver.

Although the output signals of the magnetic circuit 120 and the RF circuit 140 are shown as being tied together, it is contemplated that they may be switched such that only one set of signals is applied to the signal processor 132 at any given time.

FIG. 1E is a block diagram of example circuitry 132′ suitable for use as the demodulating signal processing circuitry 132, shown in FIG. 1D. Although this circuitry is described as being implemented in the signal processing circuitry 132, it is contemplated that all of part of it may be implemented in software running on the processor 135. The I and Q signals provided by the magnetic receiver 120 and optional RF receiver 140 are digitally sampled by the analog to digital converter (ADC) 160. The resulting sampled signals are stored in an input sample memory 162. The digital samples are then mixed by a complex mixer 164 with an I and Q signal from a carrier numerical controlled oscillator (NCO) 166 to produce I and Q baseband signals.

The resulting signal samples are processed by matched filter 168. The carrier NCO 166 may provide a carrier offset to a carrier/code divider 170 depending on the type of SPS signals being received (GPS, Galileo, GLONASS, IRNSS or BeiDou). The code generator 172 generates a code sequence associated with the signal from one of the satellites or pseudolites. The generated code sequence is then used by the matched filter 168 to process the resulting signal samples. The example matched filter processes the signal provided by the complex mixer through a filter having coefficients determined from the code sequence generated by the code generator 172. Initially, the matched filter may process the I and Q signals using multiple offsets of the code signal to align the code signal with the I and Q signals. In one implementation, the magnetic transmitters 100′ are synchronized to a common time base such that, once the alignment of the code sequence to the magnetic signal has been determined for one magnetic signal, it is known, at least approximately, for all other magnetic signals. The matched filter produces a peak value when the received magnetic signal is processed with the code signal corresponding to a particular satellite. The magnitude of the peak is representative of the strength (RSSI) of the received signal.

The matched digital signal samples (I and Q) are accumulated in the coherent sample accumulator 174. The coherent sample accumulator is configured to accumulate 1 ms intervals of the baseband I and Q signals over a 20 ms interval corresponding to the data-bit time for data transmitted in the GPS signal. The output signal provided by the accumulator 174 may be used to provide this data signal to processing circuitry (not shown) in the signal processor 132 that decodes the data signal. The data decoded from the GPS signal may include, for example, time synchronization values, almanac data and ephemeris data identifying the orbital positions of the satellites and any Doppler shifts in the frequencies of the satellite signals.

A fast Fourier transform (FFT) may be applied by the FFT module 176 to the accumulated matched digital signal samples and the resulting transformed digital signal samples may then have an absolute value function 178 applied. The absolute value function may be, for example represented by the function ABS (I,Q)=(I²+Q²)^{1/2}. The resulting values are then accumulated in a non-coherent sample (NCS) accumulator 180. The combination of the sample accumulation performed by the coherent sample accumulator 174 and the non-coherent sample accumulator 180 determine the processing gain of the receiver. The gain increases as increasing numbers of sample intervals are accumulated. The amount of accumulation, may be limited, however by the desired response time of the location system. In order to accurately determine its location, the receiver 150 desirably process signals from four satellites and/or pseudolites. Thus, the amount of processor gain achieved is balanced against the desired responsiveness of the system.

A peak sort 182 may then be applied with the peaks stored in peak memory or peak RAM 184. The peaks indicate where the strongest matches occurred between the PRN and digital signal samples. These peaks indicate the respective times at which the satellite and pseudolite signals were received. The positions of the satellites and pseudolites are known, either from the almanac and ephemeris data decoded from the RF satellite signals or from aiding data provided from a cellular network. The receiver also knows the time that the signals were sent from the satellites and pseudolites. From this data, the receiver 150 can calculate its distance from each of the satellites and pseudolites and, thus, its position.

In one implementation, the peaks in the peak RAM 184 are processed by the processor 135 according to GPS positioning algorithms to determine the location of the receiver 150. In this implementation, the processor 135 receives the timing data and the almanac and ephemeris data either from the RF satellite signals or from an aiding processor coupled to the receiver 150 by a wireless communications network, for example a cellular telephone network or a WiFi network (not shown).

FIG. 1F is a block diagram of an alternative demodulating signal processor 132 that may be used to receive signals from the magnetic transmitter shown in FIG. 1A. The example demodulating and signal processing circuitry 132 is used with a receiver 150, shown in FIG. 1D that does not include the RF IQ receiver 140. In this example, the I and Q signals received from the magnetic IQ receiver 120 are baseband signals.

The ADC 182 of receiver 132 digitizes and samples the I and Q signals received from the respective low-pass filters 128 and 130. These samples are stored in an input sample memory 188. The samples in the memory are applied to a matched filter 189 that correlates the samples to respective identification codes provided by a code generator 191, as described above. The I and Q correlation values are then applied to an absolute value function 190 which may be the same as the absolute value circuitry 178 described above, with reference to FIG. 1E. The output values provided by the function 190 are applied to a non-coherent sample accumulator 192.

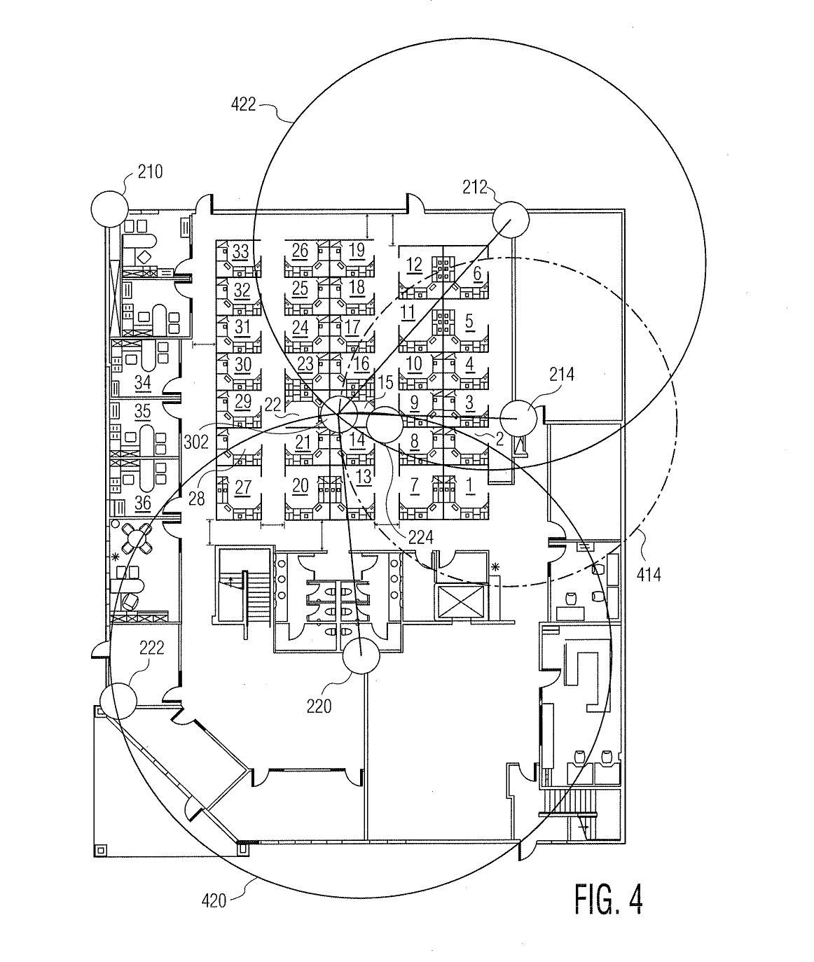

The accumulator 192 sums the absolute value correlation samples over successive intervals corresponding to the period of the identification signal generated by the source signal generator 102, shown in FIG. 1A. As described above, the amount of accumulation determines the processing gain provided by the signal processor 132. The output signal of the non-coherent sample accumulator 192 indicates the power level of each of the transmitter corresponding to the code generated by the code generator 191. This power level is stored in a memory 198 with an identification of the transmitter, provided by the code generator 191. Each of these power levels may correspond, for example, to a respective Received Signal Strength Indicator (RSSI) of the signal received from one of the beacon transmitters 100. The respective received power levels and signal source identifiers may be used, as described below with reference to FIGS. 2-4 to determine the location of the receiver 150.

It is contemplated that, at least for some magnetic signal sources, the signal processor 132, shown in FIG. 1F may not use the non-coherent sample accumulator 192. This accumulator may not be needed when the receiver 150 is sufficiently close to the beacon transmitter 100 that the processing gain provided by the accumulator 192 is not needed. In this instance, the output signal of the absolute value circuit 190 may provide a power measurement for the identification signal received from the beacon transmitter 100. As described above, the power measurement may be affected by the presence of ferromagnetic objects and relatively large conductive objects that are configured, relative to the transmitter, to generate eddy current noise. Any positioning technique using power measurement desirably takes into account the presence of such objects.

In addition, the measured power levels may be affected by the relative orientations of the antennas of the magnetic beacon transmitters and the magnetic receivers. Loop antennas typically emit The magnetic field produced by a loop antenna may not be isotropic. The use of two or three mutually orthogonal antennas for each transmitter may make the respective magnetic fields more isotropic. In one configuration, each antenna is positioned along the null axis of the other antenna(s). Activating all antennas concurrently may result in constructive and destructive interference among the emitted magnetic fields. This may be addressed by activating the antennas sequentially so that, averaged over time, the combined antennas emit a more isotropic magnetic field than would be emitted by a single loop antenna.

FIGS. 2-4 describe example positioning techniques suitable for use with magnetic beacon transmitters, such as the transmitter 100, described above with reference to FIG. 1A. The data communicated by the beacon, and the receive/transmit capabilities of the beacons vary with the different implementations, and are described with each of the techniques.

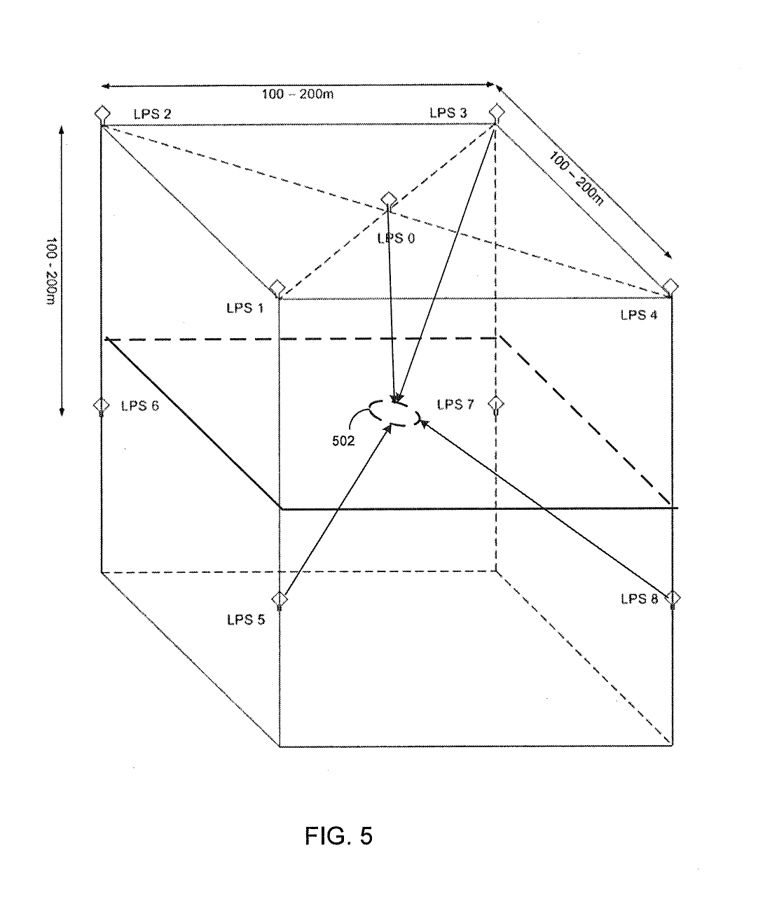

In each of the techniques, the positions of the beacon transmitters 100 are known by the receivers 150 or are transmitted by the beacon transmitters as data signals in addition to the identification signals. As described above, each beacon transmitter 100 transmits an identifiable code. Although the examples described below with reference to FIGS. 1-5 concern distinct positioning techniques, it is contemplated that multiple techniques may be combined within the same beacons/positioning system. For example, angle and range could be combined to improve positioning performance or reduce the calculation operations required. Furthermore, any of the techniques described with reference to FIGS. 2-4 may be combined with the GPS technique described below with reference to FIG. 5.

The examples below describe 2D positioning for clarity in the diagrams. It is contemplated that the same principles may be applied in three dimensions. Also for clarity the estimates of position, range, RSSI and angle are deemed perfect. In reality these would be noisy and erroneous. The system may include a measure of uncertainty in the signals received from each of the devices to compensate for the noise and errors.

Each of the positioning techniques using beacon transmitters 100 are described below with reference to FIGS. 2-4. In one example, these techniques are implemented using software, stored in the memory 137, that runs on the processor 135. The proximity technique is described with reference to FIG. 2. The centroid, fingerprinting and triangulation techniques are described with reference to FIG. 3. The trilateration, range RSSI, range timing and return time transmit techniques are described with reference to FIG. 4. In each of these FIGs. items 210, 212, 214, 218, 220 and 222 are beacon transmitters 100 or other types of magnetic signal sources that may be sensed by a magnetic receiver such as the receiver 150 shown in FIG. 1D.

Proximity

The positioning calculation for proximity chooses the closest beacon position as the device position. This technique is illustrated in FIG. 2. As shown, the true position of the receiver is at item 224. In this position, the strongest beacon transmitter signal sensed by the receiver 224 is that of the transmitter 214. Consequently, the receiver 224 determines its position as being collocated with the transmitter 214. This position is shown by item 216, adjusted slightly for clarity. Using this technique, The receiver 132 shown in FIG. 1F may detect the beacon transmitter having the strongest signal either by the output signal of the absolute value process 190 being greater than a threshold value or by examining the power levels stored in the memory 198 and selecting the transmitter corresponding to the highest recorded power level.

As described above, the measured signal strength may be affected by the presence of ferromagnetic objects, such as a steel desk, or relatively large conductive objects such as an aluminum panel in a cubicle. This type of distortion may be mitigated by placing the magnetic transmitters such the magnetic fields that they produce are relatively unaffected by these objects. For example, placing the transmitters above or immediately below an acoustic ceiling panel.

Because the proximity location sensing technique relies on signal strength, it may be desirable to limit its use to instances where the magnetic receiver is very close to the magnetic transmitter (e.g. within 1-3 meters). Sensed magnetic fields at these distances may not need to be accumulated in order to determine their relative signal strengths.

Centroid

The position calculation places the positioning device in the geometric center of the area as defined by the positions and of the observed beacons. This position can be influenced by weighting the measurements from the observed beacons (based on sensed power level and beacon position uncertainty) to improve performance. As this technique relies, at least partly, on the sensed power levels of the magnetic fields emitted by several magnetic transmitters, it is desirable for the transmitters to use multiple mutually orthogonal antennas, placed to minimize distortion from ferromagnetic object and relatively large conductive objects. As described above, for example, the transmitters may be placed near the ceiling of an open area or an area occupied by relatively low cubicles. FIG. 3 shows the determined centroid position as item 302. The actual position of the magnetic receiver is shown as item 224. The lines between the centroid position 302 and each of the magnetic signal sources 210, 212, 214, 220 and 222 illustrate the power levels of the received signals, where the power level (RSSI) is inversely related to the length of the line. The centroid is determined based on the received signal strengths, where the locations of the corresponding magnetic signal sources are known based on the transmitter identification values stored with the power levels in the memory 198. Due to distortion caused by the anisotropic nature of the magnetic field produced by a loop antenna which may be distorted by ferromagnetic and conductive objects, the signal strength measurements may not be accurate. The system may include an uncertainty in each measurement which may affect the accuracy of the measured location.

Fingerprinting

FIG. 3 is also useful for describing a location technique based on magnetic fingerprinting. This position calculation technique relies of the combined signal characteristics observed at a certain position. Each position has a distinct pattern of signals from the observable beacons transmitters. As shown in FIG. 3, these transmitters include magnetic signal sources 210, 212, 214, 220 and 222. The received signals are compared against a fingerprint database and the closest match in the database provides a position estimate. In this instance, the determined location, 302 represents an entry in the fingerprint database having stored signal strength values and associated transmitter identification values, as indicated by the respective lengths of the lines joining item 302 and each of magnetic signal sources 210, 212, 214, 220 and 222. These signal strength values are actual measured magnetic field strengths at various points throughout the monitored area. Thus, distortion caused by ferromagnetic objects or relatively large conductive objects is not a factor, as long as the objects are stationary. The fingerprint database may be stored in a memory (not shown) of the receiver 150 or in a central server (not shown). For implementations in which the database is stored in a central server, the receiver 150 may include a transceiver, for example a WiFi transceiver (not shown), that allows the receiver 150 to send its observed power levels and corresponding transmitter identification values to the central server and receive a location value from the server that correspond most closely to the observed signal strengths.

Triangulation

FIG. 3 shows one possible implementation of a triangulation technique in which each magnetic signal source includes an antenna that rotates around a vertical axis. This rotation may be a physical rotation or may be simulated by switching among multiple antennas angularly displaced from each other relative to a central axis. In this implementation, item 302 is the actual position of the magnetic receiver. There may be local maxima where magnetic fields appear to be stronger in some positions than in others. For a relatively isotropic magnetic field, the global maximum, however, should be when the receiving antenna is facing the transmitting antenna. The signal strength measurements may also be improved by having each transmitter use multiple mutually orthogonal antennas, as described above, so that each transmitter provides a relatively isotropic magnetic field. Where antennas are switched, either to simulate rotation or to prevent positive and negative reinforcing fields, it may be desirable to accumulate the repeating identification signal over an interval long enough to receive signals from each antenna in the set of antennas.

The receiver 132, shown in FIG. 1F, records multiple signal strength measurements for each signal source over a predetermined interval. The angular position of each signal source antenna during this interval is known. By correlating this position to the time at which the strongest signal is received, the receiver determines its angle relative to each of the transmitters. These angles for the transmitters 210, 212, 214, 220 and 222 are illustrated by the respective arcs 210, 312, 314, 320 and 322. The location of the receiving device 302 may then be determined by calculating the intersection of the vectors from between the receiver and all of the beacons, based on the known positions of the signal sources. Where there is uncertainty in the beacons position and/or angle, the vector is widened to provide a corridor of possible positions. The intersection then defines an area or volume rather than a point. In one example embodiment, where the field sweeps with a changing angular rate, and the rate of change of the RSSI at the positioning device may be used to estimate angle of departure. As this technique relies on the relative strength of a magnetic field, it is less affected by magnetic field distortion caused by stationary ferromagnetic and relatively large conductive objects.

This technique can also be applied to angle of arrival, where the angle that the signal arrives at the positioning device is used in the calculation. In this instance, the antennas of the magnetic signal sources may be fixed and the user may be prompted to rotate the receiver about a vertical axis while the signal strengths are measured. An internal compass of the receiver 302 may be used to determine its angular position when the strongest signal is sensed from each of the signal sources 210, 212, 214, 220 and 222.

Trilateration

Trilateration describes the technique where respective ranges of the beacons 212, 214 and 220 may be used to estimate the position of the receiver. FIG. 4 shows these beacon transmitters 212, 214 and 220 surrounded by respective circles 412, 414 and 420 indicating the perceived received signal power levels (RSSI) of the beacons. The power level is inversely related to the radius of the circle (by the inverse square law). Each circle defines the possible positions of the device from the information of a single beacon range. The intersection of the circles from each of the ranges forms the device position estimate. As shown in FIG. 4, item 302 is at the intersection of the circles and, thus, defines the position of the magnetic receiver. As with the other techniques that rely on measurements of magnetic field strength it is preferable for both the magnetic transmitters and receivers to be located away from ferromagnetic objects and for the path between the transmitter and receiver not to be blocked by relatively large conductive objects. To the extent that the system cannot compensate for distortion or noise in the received magnetic signals, a confidence value may be used in the location calculation so that the determined location may be expanded to a range of locations. It may also be desirable to use multiple mutually orthogonal antennas, as described above, so that each transmitter provides a relatively isotropic magnetic field.

Range RSSI

This method relates sensing signal power (RSSI) and relating the sensed power levels to known transmission power levels in order to calculate an approximate distance using an inverse square model (with allowance for tuning parameters for real world variations from this model). Through the model the RSSI relates to a range and the range can then be used in trilateration positioning, as described above with reference to FIG. 4. Because the sensed signal strength may depend on the relative orientations of the signal sources 210, 212, 214, 220 and 222, the user may be prompted to rotate the receiver 150 about a vertical axis while the signal strengths are measured. The highest signal strength for each signal source may then be used in the range RSSI location determination algorithm. These signal strength measurements may be distorted by ferromagnetic materials in the environment or by eddy current noise, as described above. Thus for this technique to be effective, it is desirable for both the transmitter and receiver to be positioned away from any ferromagnetic objects or relatively large conductive objects and for none of these objects to be in the path between the magnetic transmitter and receiver. In addition, each transmitter may be configured with multiple mutually orthogonal antennas, as described above, to generate relatively isotropic magnetic fields.

Range Timing

This method relies on each of the beacons 210, 212, 214, 220 and 222 of FIG. 4 transmitting a timing signal. This timing signal is received by the magnetic receiver 320 and used to form a range estimate. In a synchronous system the timing signals may all be synchronous. Alternatively, there may be a synchronization correction to each of the transmission clock signal either from the transmitted signal or from an external source. In an asynchronous system respective transmission clock offsets may be calculated by the positioning device. The processor 135 of the receiver, or an assisting server (not shown) may solve for position and time errors. A common technique for forming the estimate is a least squares estimator.

There are other methods involving differencing measurements to remove common errors. For example one measurement may be differenced with all other measurements to remove common errors. Similarly, the measurements may be differences between receivers in order to remove common transmitter errors. Both of these methods may be used to form “double differencing” solutions, removing both common receiver and common transmitter errors.

Return Time Transmit

Using this method both the receiver 320 and the beacons 210, 212, 214, 220 and 222 of FIG. 4 are able to receive and transmit magnetic signals. The range estimate is calculated from the time taken for a signal to be emitted from the receiver 302, received by a beacon and transmitted back to the receiver. The time is corrected for any processing delays, and then divided by 2 to form an estimate of the time taken to travel from the receiver 302 to each of the beacons 210, 212, 214, 220 and 222, and thus, the distance between the receiver 302 and each of the beacons. This distance can be used in a trilateration algorithm, as described above, to determine the location of the receiver 302.

Both the range-timing and return time transit methods may be affected by eddy current noise. This may occur when a relatively large conductive object is closer than the magnetic receiver 150 to the magnetic transmitter 100 and is on an angle with respect to the axis between the magnetic transmitter 100 and the magnetic receiver 150. As described above, the conductive object may generate a magnetic field in response to the varying magnetic field emitted by the transmitter 100. This magnetic field is normal to the surface of the object. Because the conductive object is offset from the axis between the transmitter 100 and the receiver 150, the induced magnetic field may be delayed and, thus, appear as multipath distortion in the signal received by the magnetic receiver 150. Because the distances inside the building are relatively small, it is contemplated that this distortion will be relatively minor. Where a signal having significant multipath distortion is received, however, the processing circuitry desirably processes the first signal to obtain accurate timing.

FIG. 5 represents an embodiment using the transmitter 100′ and receiver 150, shown in FIG. 1D, with the demodulating signal processor shown in FIG. 1E. In this implementation, the magnetic transmitters 100′ are magnetic pseudolites in a building or even perhaps below ground.

In the embodiment shown in FIG. 5, the magnetic pseudolites, referred to herein a local positioning satellites (LPS) are positioned in the center (LPS 0) and at the four corners (LPS 1, LPS 2, LPS 3 and LPS 4) of the top of the building. In this example, the magnetic pseudolites modulate a magnetic field carrier waves at, for example, 13.56 MHz (the Standard NFC and RFID carrier frequency). Each example LPS transmits a signal that is identical in format to the signals transmitted by GPS satellites. For example, the signal may be generated by a GPS satellite simulator 114, as shown in FIG. 1B.

Users within a building receive signals from four or more LPS units (magnetic pseudolites) from which a time base and an indoor location can be determined in the conventional GPS manner. As described above with reference to FIGS. 1D and 1E, by using the GPS signal processing of an RF GPS receiver. The signals received by the users may be affected by multipath distortion resulting from eddy current noise, as described with reference to FIG. 4. As with the range timing and return time transit embodiments, this distortion is expected to be minor and, when it does exist, may be mitigated by processing the first received of the multipath signals.

LPS 0 is the time reference for the system. In one implementation, it includes an RF GPS receiver 116 that receives a GPS time reference from the GPS satellites. Each of the magnetic pseudolites LPS 0, LPS 1, LPS 2, LPS 3 and LPS 4 generates a signal using the GPS spread spectrum type modulation, with its own Gold code sequence. LPS 0 transmits absolute time to the other LPS units. As shown, in the example implementation, LPS 0 is positioned on top of the building ideally at the center of the building. Each of the other magnetic pseudolites, LPS 1-4, communicates with LPS 0 either through a wired connection or via an RF receiver, for example an RF WiFi receiver (not shown). The pseudolites LPS 1-4 receive the reference time signal (RTS) at the same time and then retransmit the timing signal. All five top level LPS units therefore transmit exactly the same time signal at substantially the same time as a conventional RF GPS pseudolite.

Each LPS unit (1-4) may have an RF GPS receiver so that each unit may calculate its location. Alternatively, the location of each unit may be determined by surveying techniques and the respective determined location stored in each device. If RF GPS units are used for position determination, the LPS units desirably have the capability of using averaging or differential GPS corrections so their locations may be known to an accuracy of cm. Each LPS unit receives the same synchronized RTS signal. If the positions of the LPS units are all known then LPS 0 may be removed and one of the LPS units may transmit the RTS and its position to each of the other LPS units (1-4), then each of the other three LPSs could then apply a time correction and then each would transmit time synchronized signals as if LPS 0 was still present.

Each of the LPS units LPS 0-LPS 4 may transmit low power signals each with a unique Gold code spreading sequence in the normal GPS manner on a magnetic carrier wave (or field). Low power propagation has been demonstrated to have a range of about 10 m and it is calculated that with the aid of the coding gain available from spread spectrum that this range can be extended to between 100 m and 200 m. Depending on the vertical range of the magnetic signals, additional LPS units (LPS 5-8) may be placed near the corners of the building on other floors. These units also have unique Gold code spreading sequences. The LPS units LPS-LPS 8 may calculate their own positions using magnetic GPS receivers, such as the receiver 150, shown in FIG. 1D using magnetic signals from LPS units LPS 0-LPS 4. LPS units 5-8 are supplementary transmitters capable of being received lower down inside the building (but also above giving perhaps greater location accuracy to receivers located higher up). In all of the embodiments using magnetic pseudolites, the Gold codes assigned to the pseudolites are in the same family as the codes used in the GPS satellites but are distinct from the satellite codes. Thus, as described above with reference to FIG. 1D, the receiver 150 may use both RF GPS signals from satellites and magnetic GPS signals from the LPS units to determine its location. In the example shown in FIG. 5, the receiver determines its position, represented by the circle 502, based on signals received from LPS 0, LPS 3, LPS 5 and LPS 8.

The system could be used for location within a building or even below ground. The location of the LPSs may take into account any RSJs (steel girders) and be placed perhaps 2 m away. The placement of LPS units does not need to be accurate, the properties of GPS allows for inaccurate placement to be compensated and location accuracy to be maintained.

One of the benefits of the GPS technique shown in FIG. 5 is that a conventional handset with NFC and GPS may not need to be modified very much in order for the NFC receiver to pass the signals to the GPS processor in order for indoor location to be established.

As described herein, devices 100, 100′, 150, 132 and 132′, shown in FIGS. 1A-1F, may perform certain operations using dedicated circuitry and/or using software contained in a computer-readable medium 137 coupled to the processor 135. The software instructions may be obtained from another computer-readable medium or from another device via a WiFi transceiver (not shown), cellular transceiver (not shown) or by another communications interface such as a docking port (not shown). The software instructions may cause processor 135 and/or the signal processing circuitry 132 or 132′ to perform one or more processes described herein. Alternatively, hardwired circuitry may be used in place of, or in combination with, software instructions to implement processes described herein. Thus, implementations described herein are not limited to any specific combination of hardware circuitry and software.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A receiver comprising:
an antenna configured to receive modulated magnetic signals including a repetitive identification component signal;
magnetic signal demodulating circuitry configured to demodulate the received modulated magnetic signals to recover a baseband signal including the repetitive identification component signal;
signal processing functionality including:
a matched filter configured to correlate the received magnetic signal with a code signal corresponding to the repetitive transmitter identification component signal to provide a correlation signal; and
an accumulator configured to accumulate the correlation signals provided by the matched filter to determine a signal strength the received magnetic signal including the identification component signal; and
a processor for processing signals provided by the signal processing functionality to determine a location of the magnetic receiver.

2. The receiver of claim 1, wherein:
the magnetic signal demodulating circuitry further includes a complex mixer for recovering in-phase (I) and quadrature phase (Q) component signals from the received magnetic signal;
the matched filter correlates each of the I and Q component signals with the code signal; and
the signal processing functionality is further configured to combine the I and Q component signals provided by the matched filter to determine the signal strength of the received magnetic signal.

3. The receiver of claim 2, wherein the signal processing functionality and the processor are configured to implement signal processing according to a satellite positioning system (SPS).

4. The receiver of claim 3, further including:
a radio frequency (RF) antenna; and
RF demodulating circuitry configured to recover I and Q component signals from a satellite positioning signal received via the radio frequency antenna,
wherein the signal processing functionality is configured receive the I and Q signals provided by the magnetic signal demodulating circuitry and the I and Q signals provided by the RF signal demodulating circuitry; and
wherein the signal processing functionality and the processor are configured to process the signals provided by the RF signal demodulating circuitry and the signals provided by the magnetic signal demodulating circuitry using the SPS signal processing to determine the location of the magnetic receiver.

5. The receiver of claim 1, wherein the signal processing functionality generates an output signal indicating a transmitter corresponding to the repetitive transmitter identification signal and a signal strength value of the repetitive transmitter identification signal in the received magnetic signal.

6. The receiver of claim 5, further comprising a code generator configured to generate multiple code signals corresponding to multiple repetitive transmitter identification component signals corresponding to multiple magnetic signal transmitters, respectively, wherein the code generator is configured to sequentially apply each of the code signals to the matched filter to cause the receiver to determine a signal strength value for each repetitive transmitter identification component signal in the received magnetic signal and to associate each signal strength value with its respective magnetic signal transmitter.

7. The receiver of claim 6, wherein the processor is configured to determine the location of the magnetic receiver as being collocated with one of the magnetic transmitters associated with a largest signal strength value.

8. The receiver of claim 6, wherein the processor is configured to determine the location of the magnetic receiver by comparing the respective signal strength values associated with the respective magnetic signal transmitters with corresponding values from a fingerprint database.

9. The receiver of claim 6, wherein:
the magnetic receiver is configured to obtain a plurality of signal strength values corresponding to each magnetic signal transmitter over a predetermined interval, each of the plurality of signal strength values corresponding to a respectively different orientation of the antenna of the receiver with respect to a corresponding antenna of the magnetic signal transmitter; and
the processor is configured to:
determine respective angular displacements of the multiple magnetic signal transmitters with respect to the receiver based on the plurality of signal strength values for each of the multiple magnetic signal transmitters; and
determine a location of the receiver by triangulation based on the determined angular displacements and respective known positions of the multiple magnetic signal transmitters.

10. The receiver of claim 6, wherein the processor is configured to:
process the determined signal strength values corresponding to the respective magnetic signal transmitters by determining a centroid of the determined signal strength values based on respective known positions of the multiple magnetic signal transmitters.

11. A system comprising:
multiple magnetic signal transmitters located at respectively different positions in a volume, each magnetic signal transmitter configured to transmit a magnetic signal including a respectively different repetitive identification component;
a magnetic signal receiver, configured to receive the magnetic signals transmitted by the multiple magnetic signal transmitters, each magnetic signal receiver including:
magnetic signal demodulating circuitry configured to demodulate the received modulated magnetic signals to recover a magnetic baseband signal including the repetitive identification component signals;
signal processing functionality including:
a matched filter configured to correlate the magnetic baseband signal with respective code signals corresponding to each of the repetitive identification component signal to provide a respective correlation signal for each repetitive identification component signal; and
an accumulator configured to accumulate the respective correlation signals provided by the matched filter to determine a respective signal strength value for of each repetitive identification component signal in the received magnetic signal; and
a processor configured to associate the signal strength values with the respective transmitters and to process the signal strength values based on the positions of the transmitters to determine a location of the magnetic signal receiver.

12. The system of claim 11, wherein the signal processing functionality and the processor are configured to implement signal processing according to a satellite positioning system (SPS).

13. The system of claim 12, further comprising a radio frequency (RF) receiver including RF demodulating circuitry configured to demodulate a received RF satellite positioning signal to provide an RF baseband signal, wherein the signal processing functionality and the processor are configured to process the magnetic baseband signal and the RF baseband signal using the SPS signal processing to determine the location of the magnetic signal receiver.

14. The system of claim 11, wherein the processor is configured to determine the location of the magnetic receiver as being collocated with one of the magnetic transmitters associated with a largest signal strength value.

15. The system of claim 11, wherein the processor is configured to determine the location of the magnetic receiver by comparing the respective signal strength values associated with the respective magnetic signal transmitters with corresponding values from a fingerprint database.

16. The system of claim 11, wherein:
the magnetic signal receiver is configured to obtain a plurality of signal strength values corresponding to each magnetic signal transmitter over a predetermined interval, each of the plurality of signal strength values corresponding to a respectively different orientation of the antenna of the receiver with respect to a corresponding antenna of the magnetic signal transmitter; and
the processor is configured to:
determine respective angular displacements of the multiple magnetic signal transmitters with respect to the receiver based on the plurality of signal strength values for each of the multiple magnetic signal transmitters; and
determine a location of the receiver by triangulation based on the determined angular displacements and respective known positions of the multiple magnetic signal transmitters.

17. The system of claim 11, wherein the processor is configured to:
process the determined signal strength values corresponding to the respective magnetic signal transmitters by determining a centroid of the determined signal strength values based on respective known positions of the multiple magnetic signal transmitters.

18. The system of claim 11, wherein each of the multiple magnetic transmitters includes multiple mutually orthogonal antennas.
